(19) United States
(12) Patent Application Publication
(10) Pub. No.: US 2005/0199307 A1
(43) Pub. Date: Sep. 15, 2005

(54) Sealing method and apparatus

(76) Inventor: Robert David Eden, Cheshire (GB)

Correspondence Address: PILLSBURY WINTHROP SHAW PITTMAN LLP, 725 S. FIGUEROA STREET, SUITE 2800, LOS ANGELES, CA, 90017, US

(21) Appl. No.: 10/509,272

(22) PCT Filed: Mar. 26, 2003
(86) PCT No.: PCT/GB03/01293

§ 371 Date: May 10, 2005

(30) Foreign Application Priority Data
Mar. 28, 2002 (GB) 0207371.6

(51) Int. Cl. F16L 55/10

(52) U.S. Cl. 138/89

(57) ABSTRACT

A method and apparatus for forming a plug in a passageway. The apparatus comprises a carrier which in use is lowered into the passageway, the carrier comprising an elongate body of a material resistant to creep which supports at least two spaced apart portions that are a sliding fit in the well such that a gap is formed between each of the portions and the passageway. A body of material the melting point of which is higher than the temperature within the passageway and which expands as it solidifies is supported on the carrier. A heating device is provided for melting the body of material such that the melted material fills a space defined between the first and second portions. The carrier is cooled preferentially to ensure that the molten material solidifies rapidly adjacent the two spaced apart portions, thereby resisting flow of the material as it solidifies past the spaced apart portions. Means are provided to obstruct the gaps formed between the portions and the passageway, the obstructing means being displaced into the gaps as a result of melting of the body of material or as a result of any creep of material after it has been melted and solidified.

The present invention relates to a method and apparatus for plugging a passageway. Such passageways include underground components which may be plugged to prevent leakage of hydrocarbon fluids from those components.

In the oil and gas extraction industries, abandoned wells have to be plugged to keep the contents of deep high pressure environments which communicate with those wells from invading levels at or adjacent the surface. Plugs can be inserted at any point in a well, for example adjacent the surface or at a substantial depth. Typically, plugs are formed by injecting cement or resin into the well so as to fill for example a fifty metre length of the well. Experience has proved however that such plugs are not particularly reliable and often leak.

The known plugs tend to leak for a variety of reasons. Firstly, as the well wall is typically not particularly clean and is also covered with a hydrocarbon film, it is difficult to produce a reliable contiguous seal. Often a contiguous seal of only a metre or so in length is formed with a plug fifty times that length. Furthermore, as cement and resin based plugs solidify they contract which tends to open up a gap between the plug and the well wall. Although when a plug is initially inserted there may be little dynamic pressure in the well, after the plug is in situ substantial pressures can build up and as a result a plug which appears initially to be working satisfactory may subsequently be found to leak. If hydrocarbons leak past the plug contamination of the surface environment or for example a sub-surface aquifer can result. It is well known in the industry that a significant proportion of abandoned wells leak. As a result leaking abandoned wells often have to be re-plugged which is an expensive and time consuming operation.

It is known from U.S. Pat. No. 3,208,530 (Allen) to form a bridge plug in a well by lowering a heating element and basket assembly including a fusible element of alloy or thermoplastic material into the well, and melting the material so that it flows into the basket and solidifies in contact with the wall of the well, thereby forming a plug. Such an arrangement is not suitable for plugging abandoned wells which must be secure for many years as the alloy or thermoplastic material when exposed to pressure creeps over time, resulting in an unacceptable risk of leakage.

It has been proposed in international patent application No. GB01/04260 to form a plug suitable for an abandoned well using a material which is melted and allowed to solidify in the well, the material being of a type which expands on cooling. If however the material is allowed to cool in a manner in which it is not constrained, much of the expansion which occurs on cooling results in axial displacement of the remaining molten material rather than expansion in the radial direction so as to press against the well wall. In order to encourage the expanding metal to be forced against the well wall rather than to move axially, the material when molten is arranged so as to occupy a space between fins extending radially from a tubular carrier, the peripheral edges of the fins being a sliding fit within the well (for example leaving a gap or drift of approximately 1/16 of an inch). This does constrain to a certain extent both axial flow of the molten material and subsequent creep over time of the solidified metal, but some metal can flow through the gaps around the fins.

It is an object of the present invention to provide an improvement to the above method and apparatus.

According to the present invention there is provided an apparatus for forming a plug in a passageway, the apparatus comprising a carrier which in use is lowered into the passageway, the carrier comprising an elongate body of a material resistant to creep which supports at least two spaced apart portions that are a sliding fit in the passageway such that a gap is formed between each of the portions and the passageway, a body of material the melting point of which is higher than the temperature within the passageway and which expands as it solidifies, the body of material being supported on the carrier, and means for melting the body of material such that melted material fills a space defined between the first and second portions, wherein means are provided to obstruct the gaps formed between the portions and the passageway, the obstructing means being displaced into the gaps as a result of melting of the body of material or as a result of creep of material after it has been melted and solidified.

The invention also provides a method for forming a plug in a passageway, wherein a carrier is placed in the passageway, the carrier defining an elongate body of material resistant to creep which supports at least two spaced apart portions that are a sliding fit in the passageway such that a gap is formed between each of the portions and the passageway, a body of material the melting point of which is higher than the temperature within the passageway and which expands as it solidifies is melted in the passageway to fill a space defined between the spaced apart portions, and the carrier is cooled such that molten material adjacent the spaced apart portions solidifies before molten material between the spaced apart portions.

The invention ensures that the molten material as it solidifies and expands cannot simply flow past the spaced apart portions of the carrier. This ensures that the expanding material is forced against the wall of the passageway, resulting in a good seal. Furthermore, as the carrier is manufactured from a material which is resistant to creep, the dimensions of the carrier will not change over time even if it is exposed to pressure for many years. In addition, the solidified material is constrained by the carrier and in particular cannot flow between the carrier and the passageway wall as a result of the gaps between the carrier and the passageway wall being obstructed.

Embodiments of the present invention will now be described, by way of example, with reference to the accompanying drawings, in which:

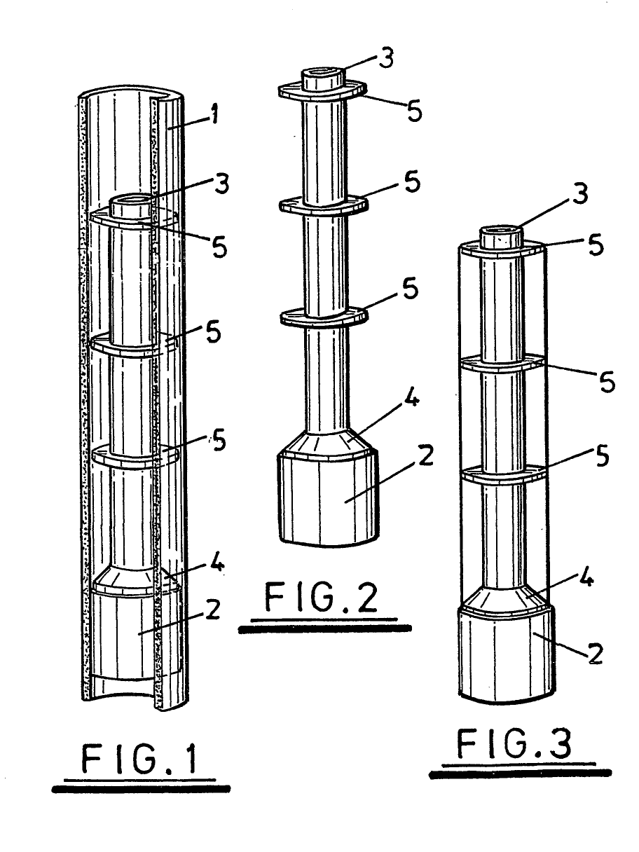

FIGS. 1 to 7 illustrate an assembly for forming a plug in a well which is described in international patent application No. GB01/04260;

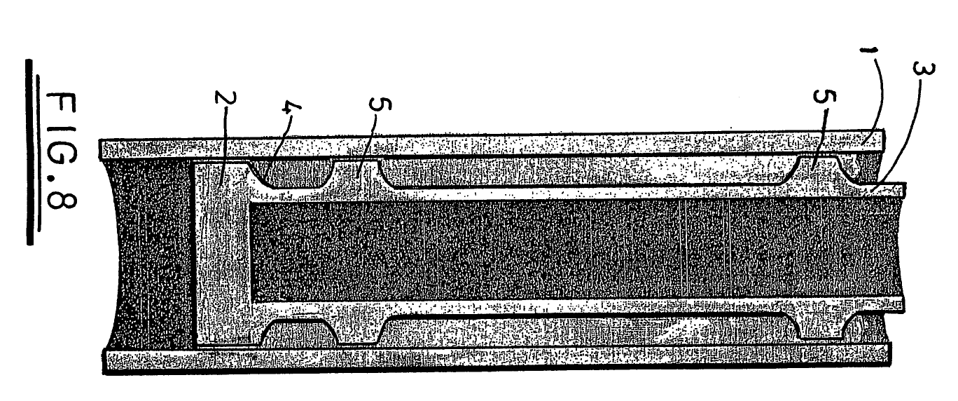

FIG. 8 illustrates a plug formed by the application of the method in accordance with the present invention;

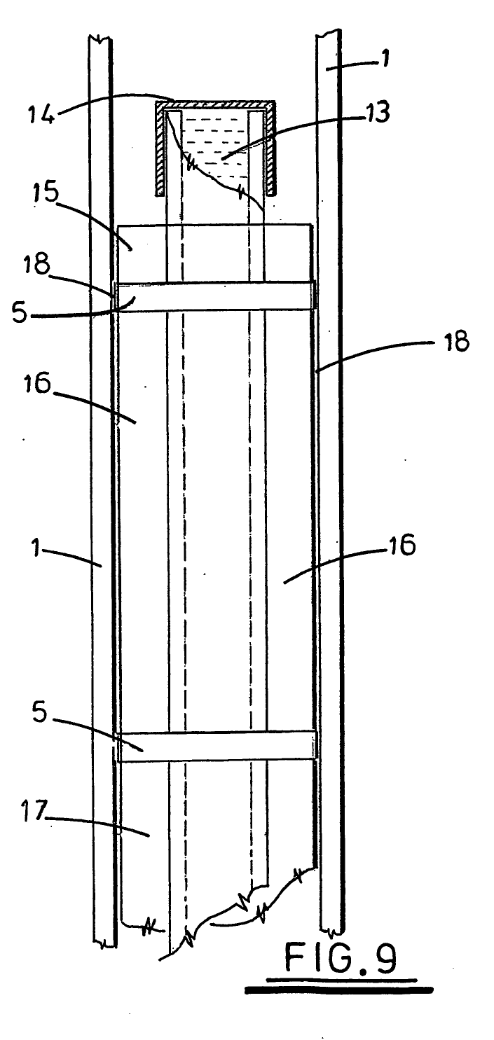

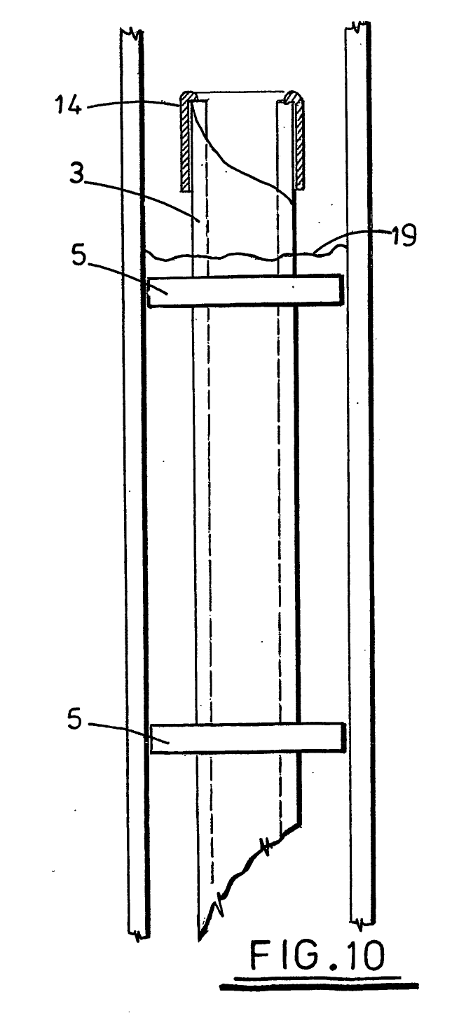

FIGS. 9 and 10 illustrate an assembly which may be used in accordance with the method of the present invention;

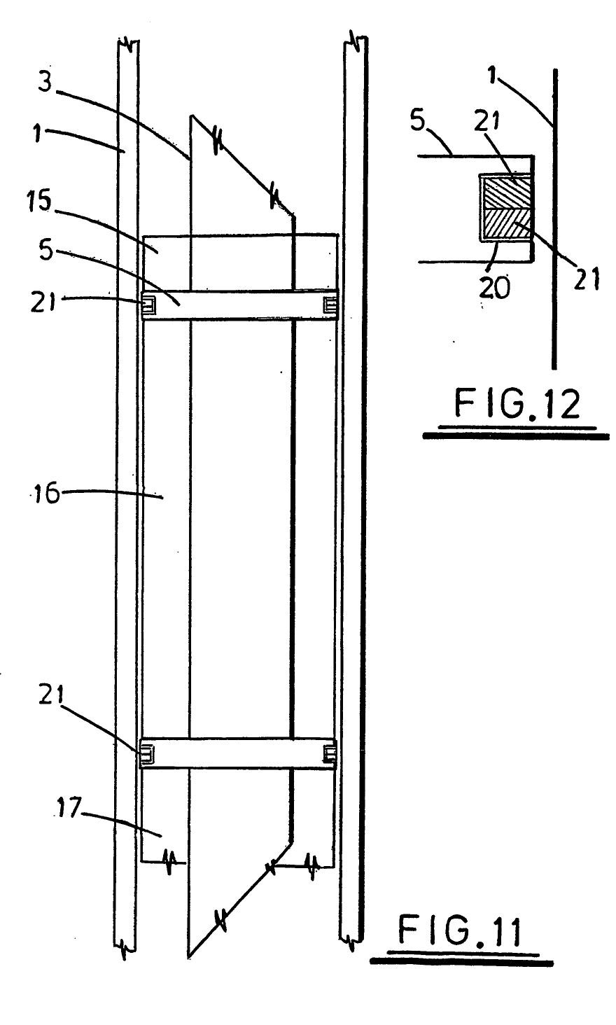

FIGS. 11, 12, 13 and 14 illustrate a first assembly in accordance with the present invention;

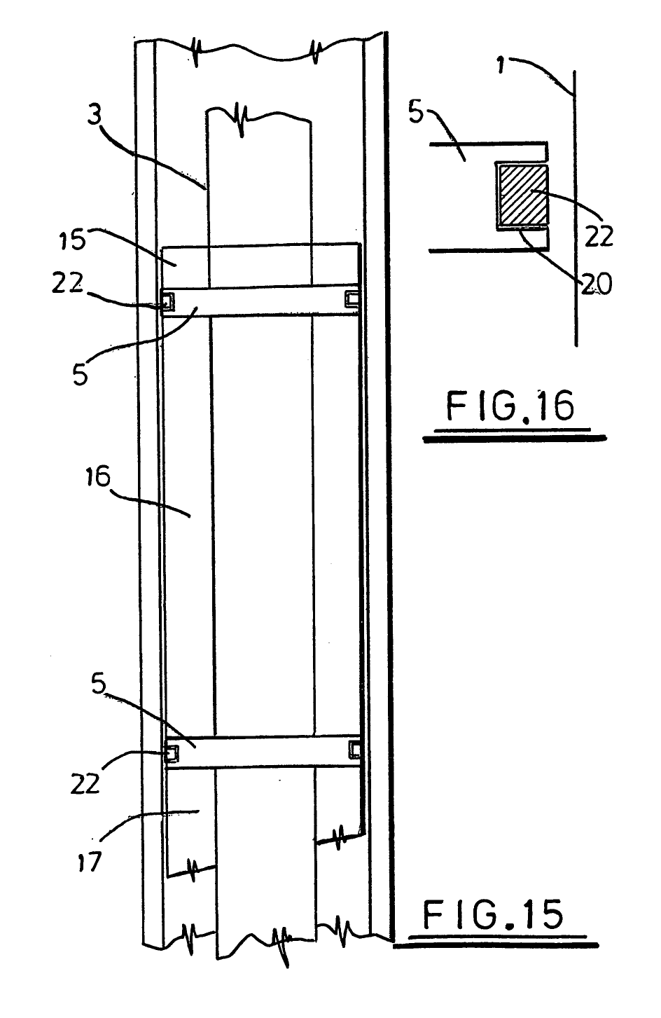

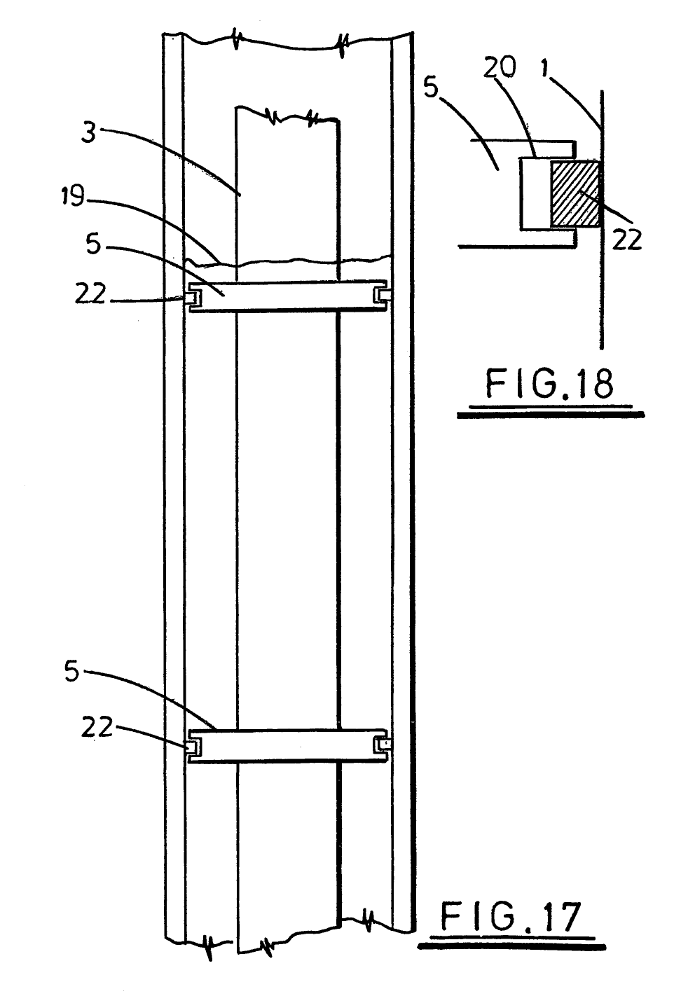

FIGS. 15, 16, 17 and 18 illustrate a second assembly in accordance with the present invention;

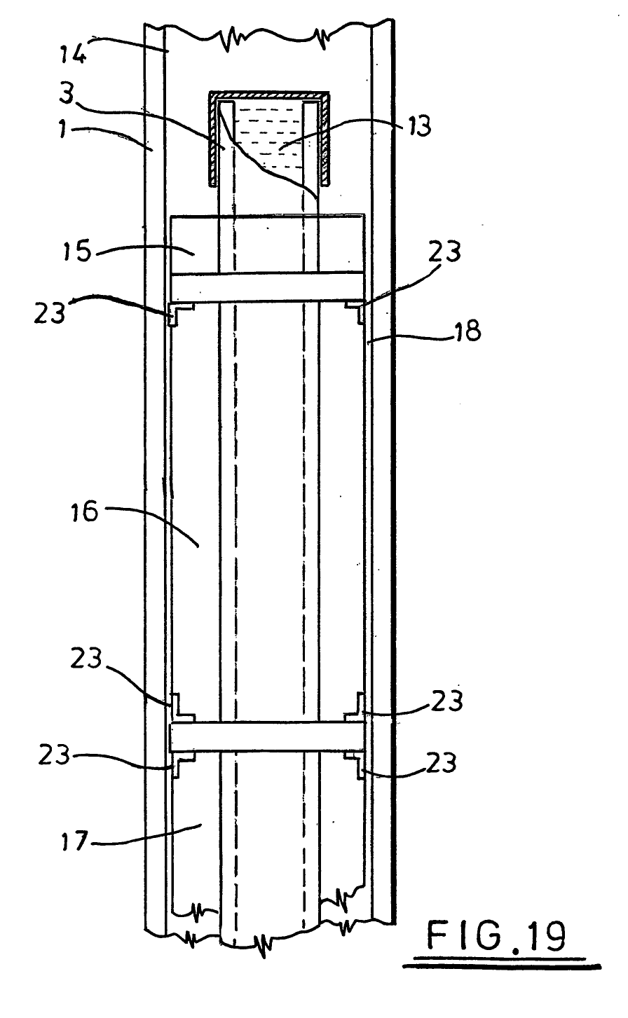

FIG. 19 illustrates a third assembly in accordance with the present invention;

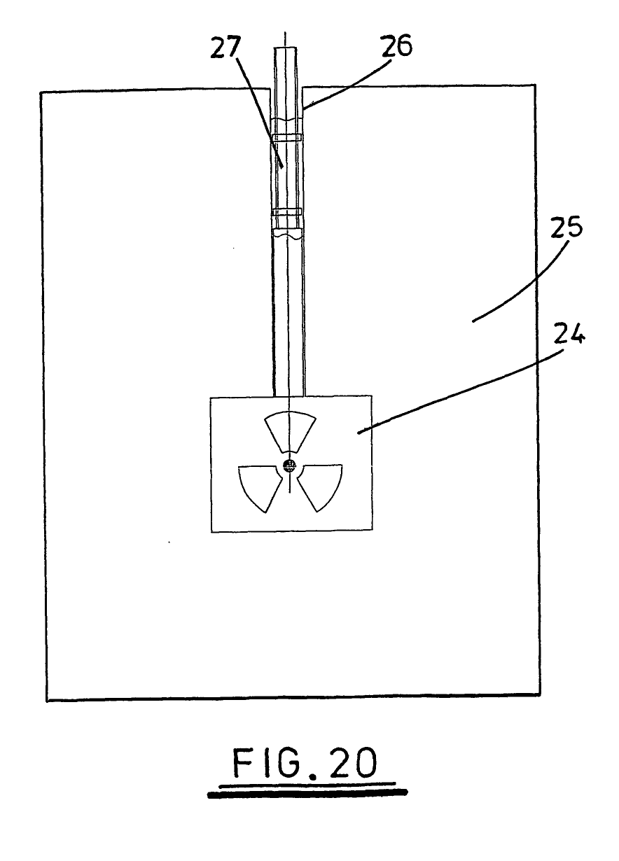

FIG. 20 illustrates an application of the present invention, in which a passageway leading to a cavity containing nuclear material is plugged;

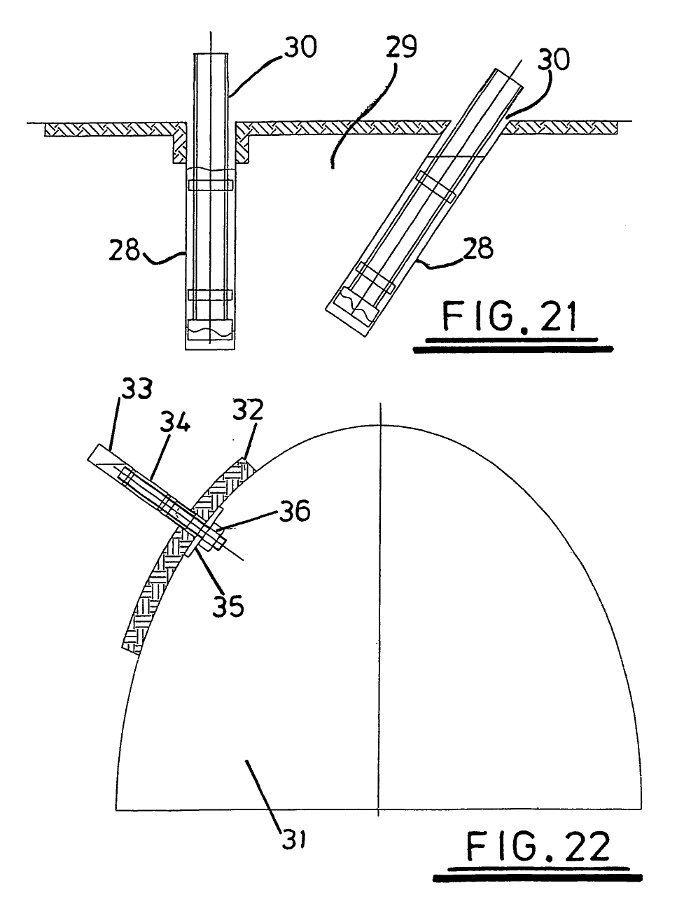

FIG. 21 illustrates an application of the present invention, in which objects are to be secured to a base;

FIG. 22 illustrates an application of the present invention in securing walls of a tunnel; and

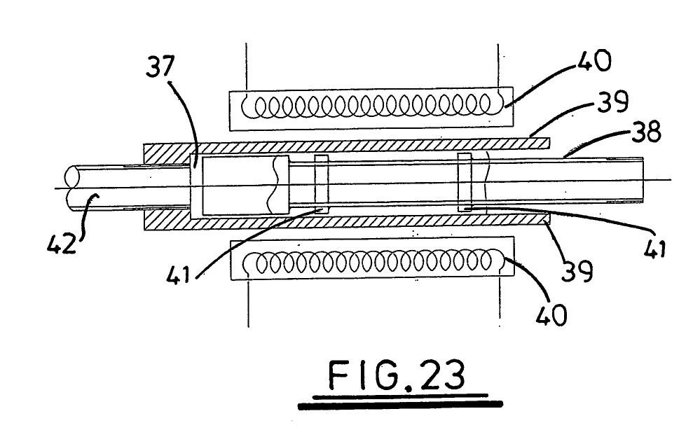

FIG. 23 illustrates an embodiment of the present invention in which heaters are used to allow removal of a formed plug from a passageway.

Referring to FIGS. 1 to 7, an assembly described in international patent application No. GB01/04260 is illustrated. The assembly is used to form a bismuth alloy plug within a wall casing 1 above a packer 2. The solid bismuth alloy plug is formed from an amount of bismuth alloy delivered in solid form on a carrier spool to the required depth within the casing 1.

The carrier spool may comprise 1% manganese steel and is therefore resistant to elongation as a result of creep. The carrier spool comprises a tubular mandrel 3. The mandrel 3 has an upper open end. The lower end of the mandrel 3 terminates in a head 4, upon which the cylindrical packer 2 (comprising for example a vulcanised rubber including 40% acrylonitrile, or a simple steel skirt) is mounted. The packer 2 may be mounted on the head by a method which includes a bonding step, thus forming a metallelastic bond. The head 4 defines a frustocone the base of which has a smaller diameter than that of the packer 2 and which tapers from the upper surface of the packer 2 to the mandrel 3. The mandrel 3 has a plurality of circular flanges defining fins 5 distributed at intervals along its length. The diameter of each fin 5 is approximately equal to the diameter of the base of the frustocone 4.

In delivery form (shown in FIG. 3), metal to be melted to form a plug locates along the length of the mandrel 3 between the head 4 and an upper fin 5, defining a cylinder extending as far as the peripheral edge of the upper fin 5. The metal may comprise, for example, pure bismuth, an admixture of 95% bismuth and 5% tin, or an admixture of 52% bismuth and 48% tin. In each case the metal may be doped with sodium. In this form the carrier spool is inserted into the casing 1 (packer end first) and lowered to the required depth.

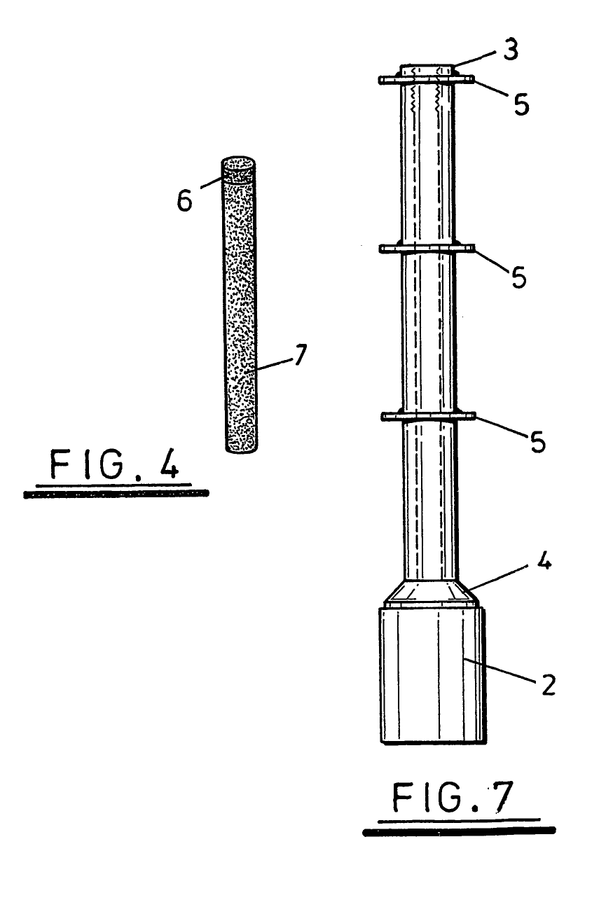

Thus positioned the bismuth alloy is melted in situ by a heater which normally locates within the mandrel 3 (but which is illustrated for clarity in FIG. 4 outside the mandrel 3). The heater defines a cylinder, an upper portion of which comprises an ignition source 6 and a lower portion of which comprises a heater element 7. The heater element 7 may comprise an admixture of aluminium and iron oxide (thermit mixture). The ignition source 6 may comprise a barium peroxide fuse and an electrical heater. It will be appreciated that other forms of both ignition source 6 and heater element 7 could be used.

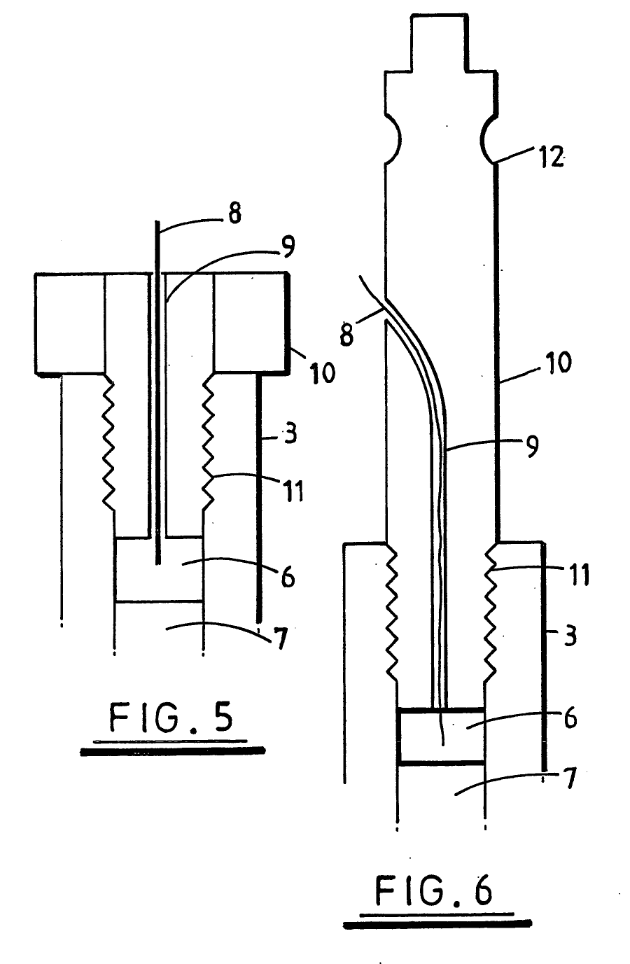

Commonly the ignition source 6 is activated using a fuse 8 (FIG. 5). The fuse 8 is preferably disposed in a bore 9 in a threaded cap 10 which engages a threaded portion 11 of the mandrel 3. The cap 10 may define a simple hollow plug (as shown in FIG. 5) or may include features such as incisions 12 (as shown in FIG. 6) which allow the cap 10 to be engaged by other equipment (not shown) such as a deployment tool. The cap 10 may define a stab connector.

Activation of the ignitor 6 triggers the heater element 7. Heat produced from the heater element 7 causes the bismuth alloy supported on the mandrel 3 to become molten. Combustion/waste gases which may be produced from the heater element 7 are allowed to be vented by the open end of the mandrel 3 and the cap 10.

The molten bismuth alloy thus slumps into the volume defined by the upper surface of the rubber packer 2 and the casing wall 1 (as shown in FIG. 1), filling the volume defined between the head 4 and the two lower fins 5.

The frustocone 4 is able to serve as a wedge that drives into the expanded bismuth alloy plug. Thus pressure from the reservoir serves to force the plug 6 against the casing wall 1.

The fins 5 serve three purposes. Firstly the fins 5 aid in forcing the expanding metal against the casing 1 by minimising axial and promoting lateral expansion. Secondly the fins 5 aid the transfer of heat from the heater element 7 to the bismuth alloy. Thirdly the fins 5 aid in reducing creep of the bismuth alloy plug up hole.

The fins 5 are a sliding fit within the well casing 1 and therefore relatively small gaps are defined between the casing and the peripheral edges of the fins 5 (and the peripheral edge of the frustocone 4). This gap is generally referred to as the “drift”. When the molten metal cools and solidifies, it expands. In the absence of the fins 5, much of this expansion would simply result in molten metal flowing upwards in the axial direction. This would not contribute to the formational of a plug tightly compressed within the casing. The fins 5 reduce this flow, hence improving the security of the plug. The present invention is concerned with improving the effect of the presence of the fins 5.

In accordance with one aspect of the present invention, the effect of the fins 5 is increased by introducing a coolant into the carrier body defined by the mandrel 3 after the plug material has been melted. This will cause material adjacent the mandrel 3 to solidify first, and thereafter cooling will be accelerated around the fins 5. As a result molten material in the gaps between the peripheries of the fins 5 and the casing 1 will solidify relatively rapidly, that solidification occurring before a substantial portion of the melted material has a chance to solidify. That still molten material is as a result effectively trapped between the frustocone 4 and fins 5 and as it cools and solidifies all the resultant expansion contributes to the application of pressure to the casing 1. Thus a very tight plug is achieved.

Coolant can be delivered to the mandrel 3 in any convenient manner. For example, simply by ensuring that the casing above the plug is filled with water is generally sufficient providing that, after the heater element 7 has been ignited and the plug material has been melted, water can penetrate into the mandrel 3, rapidly cooling the mandrel 3 and the fins 5. This approach automatically delivers the cooling water to the required location as soon as the metal which forms the plug has been melted. It will appreciated however that alternative methods for delivering coolant to the mandrel 3 could be envisaged, for example by the provision of body of coolant which is released a predetermined period after ignition of the heater element 7.

FIG. 8 is a photograph of a section through an experimental plug manufactured using a structure generally similar to that illustrated in FIGS. 1 to 7 and relying upon water to rapidly cool the mandrel 3. In the sample shown in FIG. 8, only two fins 5 were provided. It can be seen that the gaps between the outer edges of the fins 5 and the casing 1 are filled with the material making up the plug and that given the width of the fins 5 and the cooling effect of the presence of water inside the mandrel 3 the material formed within the gaps around the fins 5 will cool rapidly and certainly before much of the material trapped between the two fins 5 or between the lower fin 5 and the frustocone 4 has solidified. Subsequent solidification will therefore result in the expanding plug material exerting substantial forces against the casing 1.

Once the plug has been formed, the material making up the plug will be under compression and, given its nature, will tend to flow as a result of creep. Given that the plug is intended to be effective for many years it is important that the material forming the plug is not allowed to flow significantly. The fins 5 obstruct such flow, thereby ensuring that the plug does not fail rapidly. Given that some flow may occur however through the narrow gaps defined between the fins 5 and the casing 1 it may be that after a very prolonged period in situ the plug may flow to such an extent that it cannot maintain the required seal with the casing 1. The present invention has as one of its objectives the solution of this problem by obstructing the flow of material between the fins 5 and the casing 1.

Referring to FIG. 9, this shows an alternative structure to that shown in FIGS. 1 to 7 but of the same general configuration, that is an axially extending mandrel 3 supporting fins 5. The mandrel 3 receives a heating element of the same general type as that described with reference to FIG. 7 but the fuse structure is modified to ensure rapid penetration of coolant into the mandrel 3 after the heating element has been activated and the plug material has melted. It will be appreciated that with the fuse assemblies of FIGS. 5 and 6 water penetration may be obstructed to an extent by the cap 10 unless the cap 10 is displaced or destroyed in the heating process. In the case of the embodiment of FIGS. 9 and 10 a pyrophoric fuse 13 forms the heating element in the mandrel 3, that fuse being initiated through a fusible cap 14 which extends over the open upper end of the mandrel 3. The arrangement is such that the cap 14 remains intact until the plug material has been melted. For example, the fuse 13 may be initiated at its lowermost end such that, by the time the fuse 13 has melted the cap 14, enough material to form a plug has been melted. Igniting the fuse 13 it its bottom end provides more time for melting to occur. The mandrel 3 supports three hollow cylindrical bodies of the material which is to be melted to form the plug, that is an upper body 15 located above the upper fin 5, an intermediate body 16 located between the fins 5, and a lower body 17 which will be located between the lower fin 5 and the frustocone at the base of the assembly. The frustocone is not shown in FIGS. 9 and 10. A gap 18 is formed between the casing 1, the peripheral edges of the fins 5 and the bodies of material 15, 16 and 17. This gap 18 will be filled with water if the casing 1 is filled with water when the assembly of FIG. 9 is inserted.

Referring to FIG. 10, this shows the plug in its final form after melting and subsequent solidification of the bodies 15, 16 and 17. The result is a solid plug with an upper solidified surface 19. The fusible cap 14 melts as a result of heating by the pyrophoric fuse 13. After the fuse 13 has been consumed and the cap 14 ruptured the mandrel 3 defines an empty open ended tube into which water within the casing 1 can flow. Any water initially located in the gap 18 between the inserted assembly and the casing will be displaced by the molten material which forms the plug. Thus, when the heating element is energised, the material forming the plug melts and flows into the small gap around the inserted assembly. There is a small flow of the material downwards around the fins 5. Once the heating element has been consumed, water within the casing pours into the open upper end of the mandrel 3, causing rapid cooling of the mandrel and rapid cooling of molten material immediately adjacent the fins 5. As a result material adjacent the fins 5 and in particular between the peripheral edges of the fins and the casing 1 will solidify well before all of the material between the fins 5 has solidified. Subsequent solidification and expansion of material between the fins 5 is thus constrained so that the expansion is essentially radially outwards, causing the plug in its final form to be under high compressive force. Ensuring rapid cooling of the mandrel 3 and the fins 5 in accordance with the present invention reliably achieves the desired effect, that is constraint of much of the body of molten material by achieving rapid solidification of material around the fins.

Once the plug has been formed, the fins 5 will offer substantial resistance to creep of the plug material past the fins given the relatively narrow gaps 18 around the peripheral edges of the fins. This gap can be further reduced in magnitude however by arranging for it to be obstructed by devices which are embedded in the plug. FIGS. 11 to 14 illustrate one modification to the structure shown in FIGS. 9 and 10 which achieves blocking of the gaps around the fins.

FIGS. 9 & 10 do not show a structure such as the stab connector shown in FIG. 6 to enable the assembly to be connected to a device for lowering the assembly into the well. Such a structure will of course be provided, the structure being designed in form or manufactured from a material such that it will not obstruct the flooding of the mandrel 3 after melting of the plug material.

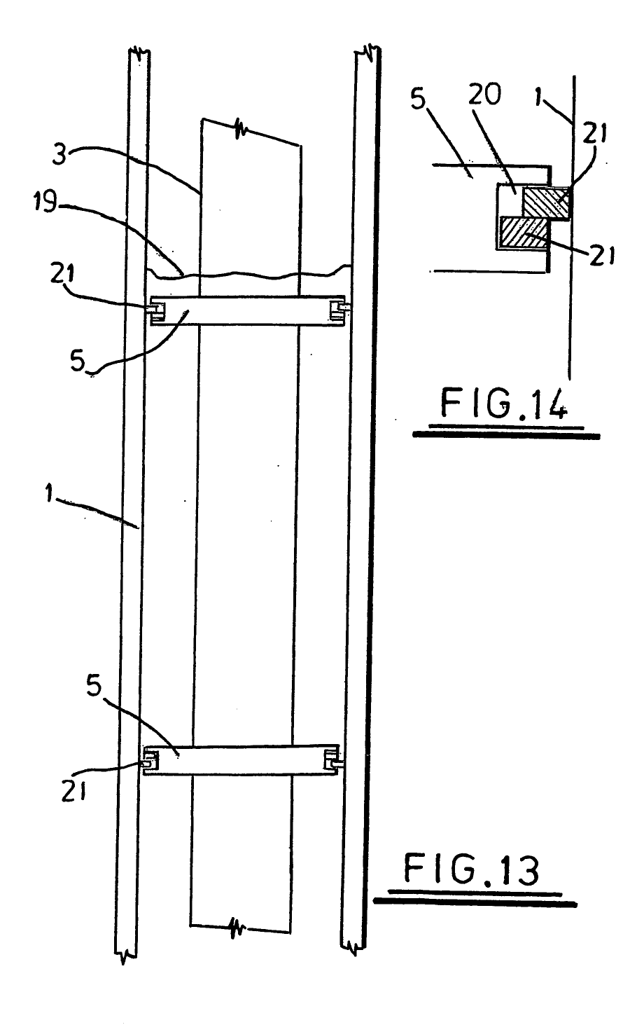

Referring to FIGS. 11 and 12, the illustrated assembly is essentially the same as that shown in FIG. 9 except for the formation of grooves 20 in the peripheral edges of the fins 5 and the incorporation into each of those grooves of a double-turn ring 21. The ring 21 is formed of a memory metal such that when heated as a result of melting of the plug material the ring springs outwards so as to obstruct the gap 18 between the peripheral edge of the fins 5 and the casing 1. FIGS. 13 and 14 illustrate the outward expansion of the rings which occurs after the plug is formed. It can be seen that the ring 21 substantially obstructs the gap between the fin 5 in which it is initially housed and the casing 1. Thus flow of molten material is further restricted and creep of the material forming the plug after it has been solidified is substantially prevented.

FIGS. 15 to 18 illustrate an alternative ring arrangement to that shown in FIGS. 12 to 14. In the arrangement of FIGS. 15 to 18, a single C-shaped ring 22 is formed in the groove 20 defined by the fin 5. The ring 22 could be formed of a memory metal which causes the ring to open after heating of the assembly. Alternatively, the C-shaped ring could simply be pre-sprung but initially restrained so as to be held within the groove 20, the spring 22 being released as a result of heating of the assembly. For example the ring 22 could be secured in position by an adhesive which itself melts when the assembly is heated. In a further arrangement, the ring 22 could incorporate for example a bimetallic strip which causes the ring to open when heated. Thus on melting of the material to form the plug the ring will open and the ring will be held in its open condition by the solidified material and will not therefore retract back into the groove 20.

Other devices for blocking the gaps 18 around the fins 5 can be envisaged. For example, the body of material 16 located between the fins 5 could have embedded within it particulates such as balls which will move into the gaps adjacent the fins 5 when the material 16 is melted. For example the body could incorporate “floating” balls of steel or aluminium and “sinking” balls of for example tungsten so that when the material is melted the floating balls will move upwards adjacent the upper fin 5 and the sinking balls will sink downwards adjacent the lower fin 5. The axially facing surfaces of the fins 5 could be frustoconical (as in the structure shown in FIG. 9) to encourage migration of the balls into the gaps adjacent the peripheral edges of the fins 5.

Rather than replying upon gravity to appropriately position particulates, it would be possible in some applications to rely upon magnetism, for example by embedding magnetised particles within the material to be melted, the magnetised particles migrating towards the gaps around the peripheral edges of the fins 5 as soon as the material is melted. It would also be possible to use magnetism in other ways to displace gap-obstructing components. For example, magnetic C-rings could be constrained in a position such that, after melting of the plug material and consequent release of the constraint, the C-rings are displaced into a position in which they obstruct the gaps. In one arrangement, in which the carrier is non-magnetic, C-shaped horseshoe magnets could be positioned such that each extends around 120° of the edge of a fin, the magnets being arranged end to end with opposed polarities and embedded in the plug material adjacent the fin. When the plug material melts, the rings will be pushed apart by repulsive magnetic forces.

It will be appreciated that if particulates are used which are spherical they will not fully seal the gaps around the fins but nevertheless will significantly obstruct flow through those gaps as a result of creep. The particulates could be of a configuration other than spherical however, the only requirement being that each of the particles is too large to pass through the gap between the fins and the casing. Typically that gap will be of the order of 1/16 of an inch assuming that the assembly is central within the casing and therefore particulates of say 1/4 inch outside diameter will be sufficiently large to ensure that they will not be able to pass through the gaps around the peripheral edges of the fins 5.

Rather than relying upon freely moving particulates to block the gaps, devices could be mounted on the fins 5 or the mandrel 3 which are constrained to move in a particular manner. For example, three arms could be pivotally mounted on the mandrel 3 at points spaced at interval of 120°, each of the arms supporting a blocking member which is moveable outwards towards the periphery of an adjacent fin, the blocking member being dimensioned and located so that when brought to a position adjacent the fin it blocks approximately 1/3 of the circumference of the gap around the periphery of that fin. Movement of the blocking members into a gap-blocking position could be ensured by manufacturing them of a material which “floats” or “sinks” as appropriate after the material forming the plug has been melted.

Blocking arrangements can be envisaged which do no require any movement relative to the inserted assembly in the absence of creep. For example, each of the fins could support a peripheral skirt extending in the axial direction from the outer edge of the fin. That peripheral skirt would be embedded in the plug after it has solidified. Creep of the plug material towards the gap around the fin would carry the skirt with it, causing the skirt to flare outwards, thereby blocking the gap. Such an arrangement is illustrated in FIG. 19 in which an L-section annular blocking member 23 has been provided below the upper fin 5 and both above and below the lower fin 5. The member 23 could be formed of for example steel so that if it was forced outwards relative to the fin 5 as a result of flow of the solidified material such flow would rapidly be obstructed. It will be noted that an arrangement such as that shown in FIG. 19 does not rely upon gravity and would be effective in any orientation.

It will be appreciated that the formation of a plug as described above has a wide range of applications. For example, FIG. 20 illustrates nuclear waste located in a cavity 24 in a block of material 25. The block of material 25 is impermeable to radiation and could, for example, include concrete and/or lead or alternatively a carbon-steel material. A passageway 26 is formed through the block of material 25 to allow the introduction of the nuclear waste into the cavity 24. When the cavity 24 within the block 25 has been filled, a plug 27 may be formed in the passageway 26 using the techniques described above.

FIG. 21 shows a further embodiment of the present invention. Here, passageways 28 are formed in a solid base 29 of for example concrete. Such passageways can be created by drilling holes into the base. If desired, the holes may be lined in a known manner so as to form smoothly lined passageways. The carriers 30 are inserted into respective passageways 28 and plugs are created in the manner described above. Thereafter, objects such as cables or the like (not shown) may be connected to the carriers 30 which are anchored to the solid base 29 by the formation of plugs. Applications of this further embodiment of the invention may include, for example, the securing of a civil engineering structure such as bridge to a rock.

FIG. 22 illustrates a tunnel 31 formed through a body of rock 32. It is known to attach roof bolts through walls of a tunnel so as to prevent subsidence of rock into the tunnel. The present invention provides a convenient way of reliably attaching such bolts. A passageway 33 is formed into the body of rock 32. A carrier 34 carrying a washer 35 and a nut 36 at one end is inserted into the passageway, such that the washer 35 and the nut 36 protrude into the tunnel 31, and the washer bears against the wall of the tunnel 31. The carrier 34 is then attached to the walls of the passageway 33 by the formation of a plug in the manner described above, so as to reliably fix the carrier 34 into the rock. The nut 36 is tightened, thereby ensuring that the washer 35 presses against the rock to resist subsidence.

In some applications, having formed a plug in the manner described above, it may be desirable to melt the solidified metal material so as to allow the carrier to be removed from the passageway, thereby unplugging the passageway. FIG. 23 illustrates a tubular member in which a passageway 37 is formed. A carrier 38 is fixed in the tubular member so as to plug the passageway 37. Sidewalls 39 of the passageway 37 are surrounded by a tubular heating element 40. The carrier 38 supports fins 41 between which material (not shown) may be melted and then solidified to form a plug in the passageway. The tubular member may be connected to one element 42 and the carrier 38 may be connected to a second element (not shown) to enable secure interconnection of the two elements.

If the two elements are to be separated, it is necessary to remove the carrier 38 from the passageway 37. This can be achieved by energising the heating element 40 to melt the solidified material, thereby allowing the carrier 38 to be removed from the passageway 37. Given that much of the molten material will be positioned to the right hand side of at least one of two fins 41 provided by the carrier 38, much of the molten material will be removed from the passageway 37 along with the carrier 38. In an alternative embodiment, the solidified material may be melted by ignition of a suitable fuse mixture provided within the carrier.

The releasable embodiment of the invention described with reference to FIG. 23 has applications in providing mechanisms similar to that shown in FIG. 21, but which allow objects to be released from the solid base, when suitably positioned heaters are energised. Furthermore, in some large-scale chain applications, a chain link can be formed from two parts which are joined using two of the arrangements illustrated in FIG. 23. Heaters can then be used to separate the two parts, thereby allowing a chain link to be broken.

1. An apparatus for forming a plug in a passageway, the apparatus comprising a carrier which in use is lowered into the passageway, the carrier comprising an elongate body of a material resistant to creep which supports at least two spaced apart portions that are a sliding fit in the passageway such that a gap is formed between each of the portions and the passageway, a body of material the melting point of which is higher than the temperature within the passageway and which expands as it solidifies, the body of material being supported on the carrier, and means for melting the body of material such that melted material fills a space defined between the first and second portions, wherein means are provided to obstruct the gaps formed between the portions and the passageway, the obstructing means being displaced into the gaps as a result of melting of the body of material or as a result of creep of material after it has been melted and solidified.

2. An apparatus according to claim 1, wherein the obstructing means comprise rings housed in grooves in the spaced apart portions, the rings being displaced into the gaps as a result of melting of the body of material.

3. An apparatus according to claim 2, wherein at least one ring comprises overlapping coils.

4. An apparatus according to claim 2, wherein each ring is C-shaped.

5. An apparatus according to claim 2 wherein each ring is formed from a memory metal which causes the ring to expand when the ring is heated as a result of melting of the body of material.

6. An apparatus according to claim 2, wherein each ring is initially secured in the groove and released as a result of melting of the body of material, the ring being sprung so as to move outward relative to the groove when released.

7. An apparatus according to claim 2, wherein each ring is formed at least in part from a bimetallic strip which when heated as a result of melting of the body of material causes the ring to move outwards relative to the groove.

8. An apparatus according to claim 1, wherein the obstructing means comprise components which are arranged so as to float or sink into the gaps when the material is melted.

9. An apparatus according to claim 8, wherein the components are particulates which are larger than the gaps, the particulates being free to move within the melted material.

10. An apparatus according to claim 9, wherein the particulates are magnetic beads the magnetisation of which is such that the beads migrate to the gaps when the material is melted.

11. An apparatus according to claim 8, wherein the components are coupled to the carrier body so as to be moveable along predetermined paths relative to the body and shaped to obstruct portions of the gaps.

12. An apparatus according to claim 1, wherein the obstructing means comprise skirts extending from the spaced apart portions into the space therebetween such that the skirts are embedded in solidified material after the plug is formed and are positioned such that any creep of the solidified material deflects the skirts outwards to obstruct the gaps.

13. An apparatus according to claim 1, wherein the spaced apart portions are defined by fins extending radially outwards from the elongate body.

14. An apparatus according to any preceding claim 1, wherein the elongate body is tubular.

15. An apparatus according to claim 14, wherein the tubular body receives a heater element.

16. An apparatus according to claim 1, wherein the passageway is a well.

17. An apparatus according to claim 1, wherein an object is fixedly attached to the carrier, such that after solidification of the material, the object is fixedly attached to the passage way.

18. An apparatus according to claim 1, comprising heating means for melting the solidified material, thereby allowing the carrier to be removed from the passageway.

19. A method for forming a plug in a passageway, wherein a carrier is placed in the passageway, the carrier defining an elongate body of material resistant to creep which supports at least two spaced apart portions that are a sliding fit in the passage way such that a gap is formed between each of the portions and passageway, a body of material the melting point of which is higher than the temperature within the passageway and which expands as it solidifies is melted in the passageway to fill a space defined between the spaced apart portions, and the carrier is cooled such that molten material adjacent the spaced apart portions solidifies before molten material between the spaced apart portions.

20. A method according to claim 19, wherein the carrier comprises an elongate tubular body from which the spaced apart portions project, and the carrier is cooled by introducing coolant into the tubular body.

21. A method according to claim 20, wherein the coolant is water above the plug in the passageway.

22. A method according to claim 19, wherein the passageway is a well.

23-24. (canceled)
